(19) United States
(12) Patent Application Publication
(10) Pub. No.: US 2016/0217496 A1
(43) Pub. Date: Jul. 28, 2016

(54) System and Method for a Personalized Venue Experience

(71) Applicant: Disney Enterprises, Inc., Burbank, CA (US)

(72) Inventors: Avi C. Tuchman, Valley Village, CA (US); Randi M. Cohn, Studio City, CA (US); Brian P. Handy, Los Angeles, CA (US)

(73) Assignee: Disney Enterprises, Inc.

(21) Appl. No.: 14/604,504

(22) Filed: Jan. 23, 2015

(51) Int. Cl. G06Q 30/02

(52) U.S. Cl. CPC G06Q 30/0269

(57) ABSTRACT

There is provides a system including a plurality of sensory indicators including a first sensory indicator at a first location and a second sensory indicator at a second location. The first sensory indicator is configured to receive a first signal from a first user beacon, determine a custom presentation based on the first signal, and generate, in response to receiving the first signal, a first sensory response to the user of the first user beacon using the custom presentation. The first sensory response guides the user from the first location to the second location. The second sensory indicator is configured to receive a second signal from the first user beacon and generate, in response to receiving the second signal, a second sensory response using the custom presentation.

### BACKGROUND

Various venues, such as stores, restaurants and shopping malls, compete to attract more customers to their sites. As a tool to attract more customers, such venues typically utilize signs, banners, and similar visual displays inside and outside the venue to attract customers to their location or to different sections within the venue or to certain products within that venue. Such visual displays are by nature aimed at the members of public, as a whole, and not any specific individuals. As such, all individuals visiting such venues receive the same visual experience from the visual displays.

### SUMMARY

The present disclosure is directed to a system and method for a personalized venue experience, substantially as shown in and/or described in connection with at least one of the figures, as set forth more completely in the claims.

### BRIEF DESCRIPTION OF THE DRAWINGS

FIG. 1 presents a system for a personalized venue experience, according to one implementation of the present disclosure.

FIG. 2 presents an environment using a system for a personalized venue experience, according to one implementation of the present disclosure.

FIG. 3 shows a flowchart illustrating a method of providing a personalized venue experience, according to one implementation of the present disclosure.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

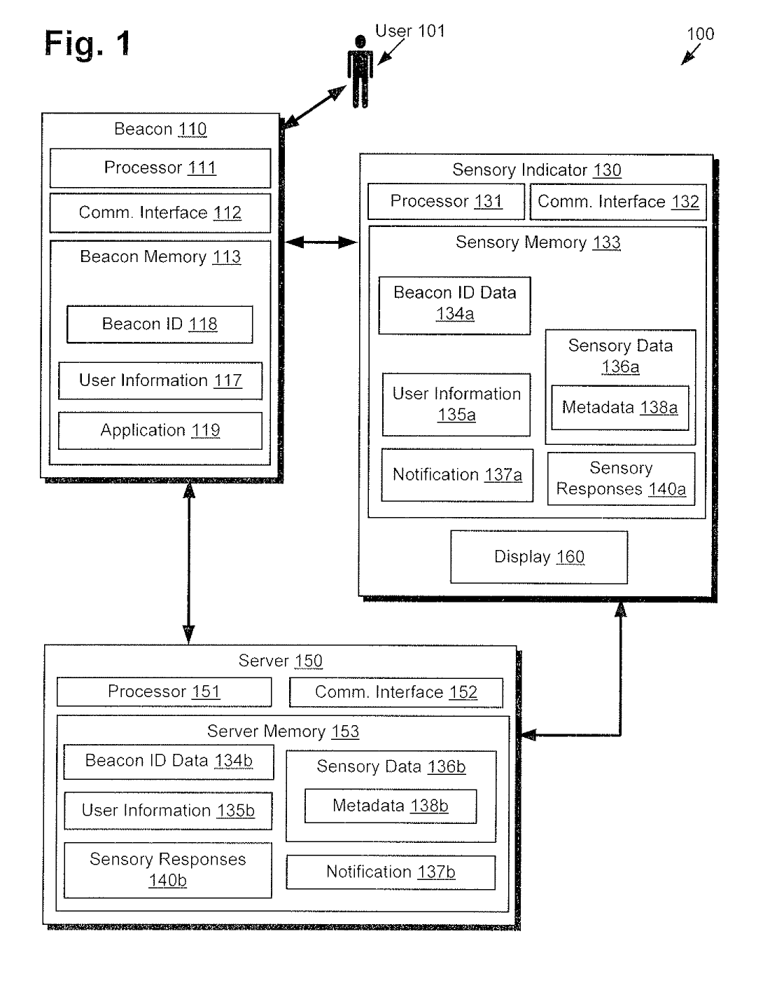

FIG. 1 presents a system for a personalized venue experience, according to one implementation of the present disclosure. System 100 of FIG. 1 includes user 101, beacon 110, sensory indicator 130, and server 150. In one implementation, beacon 110 includes communication interface 112 and beacon memory 113 including beacon ID 118. In other implementations, beacon 110 may also include processor 111 beacon memory 113 may also include one or more of user information 117 and application 119.

Sensory indicator 130 includes one or more components for providing sensory indications or responses 140 to user 101. In one implementation, sensory indicator 130 can be lights or speakers. Sensory indicator 130 may also include display 160, processor 131, communication interface 132, sensory responses 140 and sensory memory 133. Sensory memory 133 may include beacon ID data 134a, user information 135a, notification 137a, and sensory data 136a including metadata 138a. Server 150 includes processor 151, communication interface 152, and server memory 153. Server memory 153 includes beacon ID data 134b, user information 135b, sensory data 136b including metadata 138b, and notification 137b.

Beacon 110 may be an active or passive radio-frequency identification (RFID) tag, or a wireless device with a wireless communication component using a wireless communication technology, such as Bluetooth or a WiFi device, or any other wireless device capable of transmitting a signal including beacon ID 118 to sensory indicator 130. The wireless device may be a mobile phone, a watch, a necklace, or a bracelet. For example, beacon 110 can be embedded in any item that can be worn by a person. In such an example, a user may attach the item including beacon 110 on the clothing using a clip, an adhesive, a button, or any other type of attaching mechanism, or may wear beacon 110 as an electronic bracelet, a wristband or a necklace.

In an implementation where beacon 110 is embedded in a mobile phone, beacon 110 may transmit beacon ID 118 to sensory indicator 130 or beacon ID 118 may be read by sensory indicator 130 when the mobile phone is within a certain range of sensory indicator 130. In some implementations, the mobile phone may transmit a signal including beacon ID 118 in response to receiving a triggering signal from sensory indicator 130. In such an implementation, sensory indicator 130 may constantly transmit triggering signals for receipt by beacons, such as beacon 110. Sensory indicator 130 may use beacon ID 118 to determine an identity of user 101.

Processor 111 may be configured to access beacon memory 113 to store information or to execute commands or programs stored in beacon memory 113. Processor 111 may correspond to a processing device, such as a microprocessor or similar hardware processing device, or a plurality of hardware devices, capable of performing the functions required of beacon 110. Beacon memory 113 is capable of storing information, commands and programs for execution by processor 111. Beacon memory 113 may be ROM, RAM, flash memory, or any non-transitory computer memory capable of storing a set of commands. In other implementations, beacon memory 113 may correspond to a plurality memory types or modules.

Beacon 110 may utilize communication interface 112 to communicate with communication interface 132 of sensory indicator 130 and communication interface 152 of server 150 through wireless communication links denoted by double-sided arrows in FIG. 1. Communication interface 112 can utilize various wireless communication protocols, as examples, one or more of Wireless Fidelity (Wi-Fi), Worldwide Interoperability for Microwave Access (WiMax), ZigBee, Bluetooth, RFID, Algorithm Division Multiple Access (CDMA), Evolution-Data Optimized (EV-DO), Global System for Mobile Communications (GSM), Long Term Evolution (LTE), and other types of wireless interfaces.

Beacon memory 113 may also include user information 117, which can be provided by beacon 110 to sensory indicator 130. Sensory indicator 130 may use user information to provide user 101 beacon 110 a personalized experience. In some implementations, user information 117 may not be stored in beacon memory 113, instead, sensory indicator 130 may use user information 135a or information 135b to provide a personalized experience to user 101 based on beacon ID 110 that identifies user 101.

In an implementation where beacon 110 includes user information 117, user information 117 may include data about user 101. For example, user information 117 may include, but is not limited to, profile information such as the name of user 101, the gender of user 101, a location of where user 101 lives, the birthday of user 101, television programs user 101 enjoys, favorite music of user 101, favorite movies of user 101, favorite real-life and/or fictional characters of user 101, hobbies of user 101, and activities of user 101, etc. In some implementations, user information 117 may also include shopping information, such as items that user 101 needs to purchase, purchasing history of user 101, and clothing preferences of user 101 including brands and styles, etc.

It should be noted that user information 135a and 135b may include information similar to user information 117b, except that user information 117 is stored in beacon memory 113 of beacon 110 while user information 135a and 135b is stored in sensory memory 133 of sensory indicator 130 and server memory 153, respectively. Implementations of the present disclosure may store the user information in one or more of beacon 110, sensory indicator 130 and server 150.

As shown in FIG. 1, beacon memory 113 may also include application 119, such as an application running a mobile phone or mobile tablet. In such implementations, application 119 may be configured to utilize user information 117 For example, in an implementation where application 119 is created by a retailer, user 101 may use application 119 to access certain information provided by the retailer. The information provided by the retailer may be products for sale, movies, television shows, games, or any other information capable of presentation to user 101 through application 119 on a display (not shown) of beacon 110. As user 101 utilizes application 119, application 119 may store the interactions of user 101 as user information 117. For example, application 119 may determine the favorite movies, television shows, games, characters, clothing styles, brands, and other information of user 101 based on the interactions of user 101. Application 119 may store such information in user information 117 and transmit user information 117 to sensory indicator 130 and/or server 150 in order to aid in creating a more personalized experience for user 101 when presence of user 101 is detected at the retailer using beacon 110.

Sensory indicator 130 is configured to provide visual, audible, and/or touch sensory responses 140a to user 101 in response to receiving beacon 110. Sensory indicator 130 may be activated in response to receiving beacon 110, provide sensory responses 140a in response to receiving beacon 110. Sensory indicator 130 may include lights (not shown), speakers (not shown), display 160 and/or other devices capable of providing sensory responses 140a to user 101. Sensory indicator 110 may interact with user 101, for example, through touch or changing color. For example, when sensory indicator 110 detects that user 101 is stepping away, sensory indicator 110 may say farewell to user 101 by displaying an image, playing an audio sound, changing light colors or turning off. In one implementation, sensory indicator 110 may include lights along the path in a venue or a store, and the lights may turn on as user 101 approaches the lights and go off as user 101 walks passed the lights.

For example, in some implementations, display 160 may be a television display, which may be off prior to receiving beacon 110, or may be displaying a generic and impersonalized image or video prior to receiving beacon 110 from beacon 110. As an example, once sensory indicator 130 receives beacon 110, sensory indicator 130 may access user information 117 (or 135a or 135b) to determine a favorite character of user 101. Once the favorite character is determined, display 160 may play a video clip selected from sensory responses 140a including the favorite character of user 101. The video clip may include a personalized message for user 101, such as the name of user 101, a favorite item of user 101, or another message using user information 117b. In some implementations, the video clip may invite user 101 into a venue, such as a store, for example, or direct user 101 to a location within the store where products or items known to be of interest to user 101 may be found.

In another implementation, sensory indicator 130 may be an array of LED lights, arranged on a floor or ceiling of a store, for example. In response to sensory indicator 130 receiving beacon 110, the array of LED lights may direct user 101 to a location in the store. For example, the array of LED lights may symbolize fairy dust, and in response to an audible and/or visual cue to follow the fairy dust, the array of LED lights may sequentially light up in the direction of a location within the store where products or items known to be of interest to user 101 may be found.

In some implementations, there may be more than one sensory indicator 130, such as a television display and an array of LED lights. In such an implementation, each sensory indicator may communicate with other sensory indicator(s) to provide a personalized navigated experience through the store for user 101.

Also illustrated in FIG. 1, sensory indicator 130 includes processor 131, sensory memory 133, and communication interface 132. It should be noted that each of processor 131, sensory memory 133, and communication interface 132 of sensory indicator 130 may be similar to processor 111, beacon memory 113, and communication interface 112 of beacon 110 Processor 131 of sensory indicator 130 may be configured to access sensory memory 133 to store received input or to execute commands, processes, or programs stored in sensory memory 133.

Sensory indicator 130 may utilize communication interface 132 to communicate with communication interface 112 of beacon 110 and communication interface 152 of server 150 through communication links (denoted by double-sided arrows in FIG. 1). Communication interface 132 can utilize, as examples, one or more of Wireless Fidelity (Wi-Fi), Worldwide Interoperability for Microwave Access (WiMax), ZigBee, Bluetooth, RFID, Algorithm Division Multiple Access (CDMA), Evolution-Data Optimized (EV-DO), Global System for Mobile Communications (GSM), Long Term Evolution (LTE), and other types of wireless interfaces.

Sensory memory 133 includes beacon ID data 134a which may be compared against beacon ID 118 by sensory indicator 130 to determine an identity of user 101 and to generate one of sensory responses 140a personalized to user 101. Beacon ID data 134a may include a listing of all acceptable beacons. Sensory indicator 130 can therefore use beacon ID data 134a after receiving beacon ID 117 from beacon 110 to determine an identity of user 101 and corresponding user information 135a of user 101 by comparing beacon ID 117 to beacon ID data 134a. If beacon ID data 134a does not include beacon ID 117, sensory indicator 130 may request beacon ID data 134b from server 150 to identify user 101. In some embodiments, sensory indicator 130 may simply use the receipt of beacon ID 118, with or without comparing with beacon ID data 134a, to provide a personalized experience to user 101. For example, by simply detecting a presence of user 101, sensory indicator 130 may provide sensory indications or responses 140a to user 101, e.g. directing user 101 to one or more locations within the store using an animated character, such as a cartoon character welcoming user 101 to a children store.

Also illustrated in FIG. 1, sensory memory 133 includes user information 135a. It should be noted that user information 135a may be similar to user information 117 of beacon 110. User information 135a may include additional information of user 101 downloaded from user information 135b on server 150. For example, user information 135b on server 150 may include additional information determined using user information 117 and user information 135a, such as favorite movie clips, favorite characters, or other information determined and calculated based on each of user information 117 and user information 135a. As such, when sensory indicator 130 accesses user information 135a, user information 135a may also include user information 135b retrieved from server 150 and user information 117 retrieved from beacon 110 in order to generate a personalized sensory response from sensory responses 140a.

As shown in FIG. 1, sensory memory 133 may include sensory data 136a, such as metadata 138a. Sensory may data 136a include data that is generated or recorded while sensory indicator 130 was active. As such, sensory data 136a may include, but is not limited to, pictures, movies, or interaction data between user 101 and sensory indicator 130. For example, in one implementation, a first sensory indicator, such as a television may use sensory data 136a to start playing videos, images, and/or sounds, and a second sensory indicator, such as another television, in a vicinity of the first sensory indicator, may continue playing the playing videos, images, and/or sounds for continuous interaction with user 101 to provide a personalized experience with sequential play at various locations within the same venue, as user 101 moves from location to location and presence of user 101 is detected at each location using beacon 110.

Metadata 138a may include the identity of beacon 110 that activated sensory indicator 130, the identity user 101 who activated sensory indicator 130, a time when sensory data 136a was generated, a location of where sensory data 136a was generated, the character presented to user 101 by sensory indicator 130, and/or a portion within a personalized video clip that was displayed to user 101 by sensory indicator 130. As such, sensory indicator 130 generates metadata 138a after sensory data 136a is presented to user 101, and stores metadata 138a in sensory memory 133. For example, sensory indicator 130 may generate metadata 138a after a portion of video, image, and/or sound is presented to user 101, to record the identity of beacon 110 that activated sensory indicator 130, the location of beacon 110 that activated sensory indicator 130, and the portion that was presented to user 101.

As shown in FIG. 1, sensory memory 133 may also include notification 137a. Notification 137a is configured to be transmitted to beacon 110. For example, in an implementation that beacon 110 includes a display, such as a cell phone, notification 137a is delivered to beacon 110 for display to user 101. Notification 137a may be a notification that user 101 is entering an environment using sensory indicator 130, so that user 101 is aware that sensory indicator 130 is going to access application 119 or user information 117 on beacon 110, for example. In some implementations, notification 137a may request authorization from user 101 to interact with access beacon 110 or receive information 117 from beacon 110.

For example, in one implementation, sensory indicator 130 may request authorization from user 101 to use the name, location, or other more personal information of user 101 when presenting a personalized experience to user 101. Once notification 137a is transmitted to beacon 110, user 101 may accept the request to access or use certain user information 117 or 135a, and the acceptance is then sent to sensory indicator 130. In return, sensory indicator 130 creates more personalized sensory responses 140a for presentation to user 101. For example, sensory responses 140a may include the name of user 101, the location of user 101, and/or other more personal information of user 101.

For another example, in another implementation, user 101 in control of beacon 110 may be a parent or guardian of a child, but the environment is tailored to the child, such as a children's store. In such an implementation, application 119 may include user information 117a relating to the child, rather than the parent or guardian. As such, sensory indicator 130 may transmit notification 137a to request access to beacon 110 from the parent or guardian in order to generate sensory responses 140a personalized for the child. In such an implementation, notification 137a may also request a level of privacy for the child, and/or a parental control level in order to also personalize the experience to the parental preferences of the parent or guardian. If authorized, the display at the entrance of the store may play a character that welcomes the child to the store by name.

Sensory responses 140a are generated and presented using user information 135a and sensory data 136a to create a personalized experience for user 101 in the environment. Depending on the implementation, sensory responses 140a may be different for each type of sensory indicator 130. For example, if sensory indicator 130 is a display, sensory responses 140a include videos, images, or other data capable of being presented by the display. For another example, if sensory indicator 130 is an array of LED lights, sensory responses 140a include different lighting sequences and patterns. For yet another example, if sensory indicator 130 is a speaker, sensory responses 140a include different sound sequences, sound effects, or other audible information.

Sensory responses 140a may be generated by sensory indicator 130 using user information and sensory data 136a. For example, user information 135a is used by sensory indicator 130 to determine a favorite character of user 101 based on viewing history of user 101, prior purchases or user 101, and/or other user information 135a of user 101. Once the favorite character of user 101 is determined, sensory responses 140a include personalized responses that feature the favorite character of user 101. If user 101 has a favorite character named “CHARACTER1” then in response to receiving triggering signal 115a, sensory indicator 130 may access user information 135a to create at least one of sensory responses 140a that includes “CHARACTER1”.

In such an example, the at least one of sensory responses 140a may include “CHARACTER1” inviting user 101 into environment using visual and audible cues, directing user 101 to a location in the environment where products or items known to be favorable to user 101 are located, and/or welcome user 101 and provide a personalized message to user 101.

In some implementations, sensory responses 140a may be determined based on a large number of beacons, including beacon 110, all sending triggering signals to sensory indicator 130. For example, sensory indicator 130 may receive triggering signals from a plurality of beacons, including beacon 110, and make a determination that a majority of the plurality of users are fans of “CHARACTER1” and select one of sensory responses 140a that utilizes “CHARACTER1” and is tailored to the majority of the users.

Sensory responses 140a are also generated using sensory data 136a. For example, in some implementations, there may be more than one sensory indicator 130 in the environment. After each of sensory responses 140a are presented by each sensory indicator 130, sensory data 136a related to each of sensory responses 140a is stored in sensory memory 133 as metadata 138a. Thus, each other sensory indicator 130 in the environment may access sensory data 136a to determine a proper next sensory response of sensory responses 140a based on sensory data 136a.

For example, a second sensory indicator 130 may use sensory data 136a to determine the previous sensory responses 140a presented to user 101, and the previous locations of each sensory indicator 130 that previously presented sensory responses 140a to user 101. In response, the second sensory indicator 130 may direct user 101 to another location within the environment using “CHARACTER1” that user 101 has not previously visited.

Also illustrated in FIG. 1, sensory indicator 130 may include display 160. Display 160 is configured to present sensory responses 140a to user 101 in response to sensory indicator 130 receiving beacon ID 118. During periods of time where sensory indicator 130 is not presenting one of sensory responses 140a, display 160 may display a generic or an impersonal video, image, or a blank screen.

Display 160 may comprise a liquid crystal display (“LCD”), a light-emitting diode (“LED”), an organic light-emitting diode (“OLED”), or another suitable display screen that performs a physical transformation of signals to light. In the present implementation, display 160 is a part of sensory indicator 130 and may be configured for touch recognition. However, in other implementations, display 160 may be external to sensory indicator 130. Display 160 may alternately comprise a projector and a projector screen, a holographic display, and/or a transparent screen, or any other medium providing a visual presentation.

In some implementations, display 160 may appear as a mirror, and when beacon 110 transmits beacon ID 118 to sensory indicator 130, sensory indicator 130 may present a video clip, an image, and/or an audio message to user 101 encouraging user 101 to buy the item or clothing user 101 is on in front of the mirror.

Server 150 is configured to communicate with beacon 110 and/or sensory indicator 130 to transmit and receive user information 117, beacon ID data 134b, sensory data 136b, sensory responses 140b, and notification 137b. Server 150 may be a local server or a remote server which requires access over a network. It should be noted that beacon ID data 134b, user information 135b, sensory responses 140b, sensory data 136b, metadata 138b, and notification 137b are similar to beacon ID data 134a, user information 135a, sensory responses 140a, sensory data 136a, metadata 138a, and notification 137a, respectively.

Server 150 may provide dynamic updates of user information 135b, beacon ID data 134b, sensory responses 140b, sensory data 136b, and notification 137b to beacon 110 and/or sensory indicator 130 as new users and new information are generated. For example, when user 101 registers beacon 110, beacon ID data 134b is updated to include beacon ID 118, and the updated beacon ID data 134b can be transmitted to sensory indicator 130 for storage in beacon ID data 134a.

As another example, when user 101 watches a new television show or movie, plays a new game, and/or buys different products, user information 135b is updated to include the new information and the updated user information 135b is transmitted to beacon 110 for storage in user information 117 and/or to sensory indicator 130 for storage in user information 135a.

For yet another example, when a new character is created, or a new type of sensory indicator 130 is created, server 150 may update sensory responses 140b with new sensory responses 140b that include the new character, or include new sensory responses 140b tailored to the new type of sensory indicator 130. After server 150 updates sensory responses 140b, sensory responses 140b are transmitted to sensory indicator 130 to be stored in sensory responses 140a.

In another example, once beacon ID 118 triggers sensory indicator 130 and sensory data 136a is updated, sensory indicator 130 may communicate sensory data 136a to server 150 for storage in sensory data 136b. As a result, when beacon ID 118 triggers another sensory indicator, at a later time, server 150 may transmit sensory data 136b to that sensory indicator to update the sensory data on that sensory indicator. As a result, this second sensory indicator 130 may generate sensory responses that provide a logical transition from sensory responses 140a generated by the first sensory indicator 130, for example.

For another example, when user 101 responds to notification 137a, sensory indicator 130 may transmit the response to server 150 to update notification 137b. As a result, when beacon ID 118 triggers another sensory indicator, at a later time, server 150 may transmit the response from user 101 to a second sensory indicator so that the second sensory indicator follows the same parental controls and/or other preferences of user 101 without having to again request a response from user 101.

It should be noted that each of processor 151, server memory 153, and communication interface 152 of server 150 may be similar to processor 131, sensory memory 133, and communication interface 132 of sensory indicator 130. For example, processor 151 of server 150 may be configured to access server memory 153 to store received input or to execute commands, processes, or programs stored in server memory 153.

Server 150 may utilize communication interface 152 to communicate with communication interface 112 of beacon 110 and communication interface 132 of sensory indicator 130 through communication links (denoted by double-sided arrows in FIG. 1). Communication interface 152 can utilize, as examples, one or more of Wireless Fidelity (Wi-Fi), Worldwide Interoperability for Microwave Access (WiMax), ZigBee, Bluetooth, RFID. Algorithm Division Multiple Access (CDMA), Evolution-Data Optimized (EV-DO), Global System for Mobile Communications (GSM), Long Term Evolution (LTE), and other types of wireless interfaces.

Although FIG. 1 illustrates one beacon 110, one sensory indicator 130, and one server 150; the present disclosure is not limited to the implementation of FIG. 1. In other implementations, there may be any number of beacons, sensory indicators, and servers in communication with each other. For example, in one implementation, there may be multiple beacons transmitting triggering signals to multiple sensory indicators.

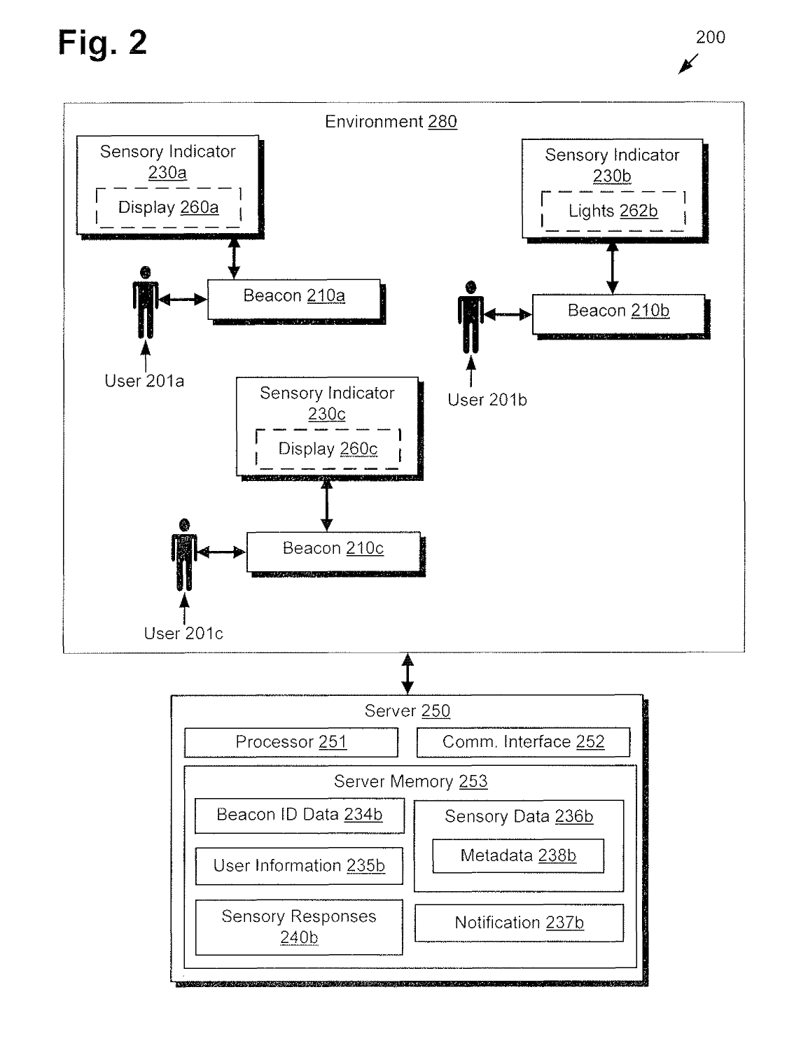

Referring now to FIG. 2, FIG. 2 presents an environment using a system for a personalized venue experience, according to one implementation of the present disclosure. System 200 includes environment 280 and server 250. Environment 280 includes sensory indicator 230a including display 260a, sensory indicator 230b including lights 262b, sensory indicator 230c including display 260c, beacon 210a, beacon 210b, beacon 210c, user 201a, user 201b, and user 201c. Server 250 includes processor 251, communication interface 252, and server memory 253. Server memory 253 includes beacon ID data 234b, user information 217c. sensory data 236b including metadata 238b, sensory responses 240b, and notification 237b. It should be noted that server 250 corresponds to server 150 of FIG. 1, sensory indicator 230a, sensory indicator 230b, and sensory indicator 230b each correspond to sensory indicator 130 of FIG. 1, and beacon 210a, beacon 210b, and beacon 210c each correspond to beacon 110 of FIG. 1.

Illustrated in FIG. 2, system 200 includes environment 280 including user 201a, user 201b, and user 201c. Environment 280 may be a store, such as a grocery store, a merchandise store, a toy store, a clothing store, or any type of store, a convention floor, or any environment or venue suitable for personalized interactions with users or visitors.

Also illustrated in FIG. 2, environment 280 includes user 201a, user 201b, and user 201c who may be the same user at different locations within environment 208. However, in other implementations, user 201a, user 201b, and user 201c may each be different users within environment 280.

Also illustrated in FIG. 2, environment 280 includes sensory indicator 230a, sensory indicator 230b, and sensory indicator 230c. Each of sensory indicator 230a, sensory indicator 230b, and sensory indicator 230c are located at different locations within environment 280. Sensory indicator 230a may include display 260a, similar to display 160 of FIG. 1, sensory indicator 230b may include lights 262b which may include an array of LED lights, and sensory indicator 230c may include display 260a, similar to display 160 of FIG. 2.

Also illustrated in FIG. 2, environment 280 includes beacon 210a, beacon 210b, and beacon 210c. In an implementation where user 201a, user 201b, and user 201c are the same user at different locations within environment 280, beacon 210a, beacon 210b, and beacon 210c may be the same beacon in possession of the same user as the user moves around environment 280. In an alternate implementation where user 201a, user 201b, and user 201c are different users within environment 280, beacon 210a, beacon 210b, and beacon 210c may be different beacons in possession of each user 201a, user 201b, and user 201c, respectively. In such an implementation, each of beacon 210a, beacon 210b, and beacon 210c may be similar or different types of beacons. For example, beacon 210a and beacon 210b may be cell phones while beacon 210c is an electronic bracelet worn by user 210c that includes an RFID tag.

Also illustrated in FIG. 2, system 200 includes server 250. Server 250 may be in communication with each part of environment 280 including sensory indicator 230a, sensory indicator 230b, sensory indicator 230c, beacon 210a, beacon 210b, and beacon 210c, such that any information exchanged between any part and server 250 may be communicated to each other feature in environment 280. As such, each of sensory indicator 230a, sensory indicator 230b, sensory indicator 230c, beacon 210a, beacon 210b, and beacon 210c can dynamically and actively be updated with information exchanged between each of sensory indicator 230a, sensory indicator 230b, sensory indicator 230c, beacon 210a, beacon 210b, and beacon 210c and server 250. Each of sensory indicator 230a, sensory indicator 230b, sensory indicator 230c, beacon 210a, beacon 210b, and beacon 210c may be updated by server 250 similar to the updating of beacon 110 and sensory indicator 130 from server 150 described with respect to FIG. 1 above.

In one implementation, sensory indicator 230a may be located at a storefront, and when user 201a is within a defined proximity of sensory indicator 230a, beacon 210a may transmit a beacon ID, such as beacon ID 118 in FIG. 1, to sensory indicator 230a. In response to receiving beacon ID 118, sensory indicator 230a may access user information stored on sensory indicator 230a, or may request user information 217c from server 250. Sensory indicator 230a may then determine that user 201a has a favorite character “CHARACTER1” based on the user information. Once the determination of the favorite character has been made, sensory indicator 230a may generate a sensory response for presentation on display 260a, such as one of sensory responses 240b on server 250. The sensory response may include a video clip of “CHARACTER1” inviting user 201a into the store and directing user 201a to the location of sensory indicator 230b, for example. Information about the sensory response may then update sensory data on sensory indicator 230a and transmit the sensory data to server 250 to update sensory data 236b.

In response, user 201a may proceed to the location of sensory indicator 230b within environment 280 illustrated by user 201b. When user 201b is within a defined proximity of sensory indicator 230b, beacon 210b may transmit a beacon ID to sensory indicator 230b. Lights 262b of sensory indicator 230b may include an array of LED lights, which in response to receiving the triggering signal, generate a sensory response which may include the LED lights lighting up sequentially in the direction of sensory indicator 230c to provide a navigational tool for user 201b toward sensory indicator 230c. In other implementations, lights 262b may be the lights used to illuminate environment 280, and in response to receiving the triggering signal lights 262b are turned off and then on in sequential order in the direction of sensory indicator 230c, for example. The direction of the sequential lighting may direct the user toward a group of products featuring “CHARACTER1” because, based on the user information and sensory data 236b received from server 250, user 201b is more likely to buy a product featuring “CHARACTER1” than another product. Information about the sensory response may then update sensory data on sensory indicator 230b and transmit the sensory data to server 250 to update sensory data 236h.

As such, sensory indicator 230c may be located in the area of the products featuring “CHARACTER1”. User 201b may then proceed to the location of sensory indicator 230c, indicated by user 201c in environment 280 of FIG. 2. When user 201c is within a defined proximity of sensory indicator 230c, beacon 210c may transmit a triggering signal to sensory indicator 230c. In response to receiving the beacon ID, sensory indicator 230c may generate a sensory response for presentation on display 260c using sensory data 236b received from server 250, such as one of sensory responses 240b on server 250. The sensory response may include “CHARACTER1” directing user 201c to a certain toy, providing user 201c information about discounts or coupons, and/or directing user 201c to another location within environment 280 that may have other items that are potentially favorable to user 201c based on the user information of user 201c.

In another implementation, each of user 201a, user 201b, and user 201c are different users at different locations within environment 280 and sensory indicator 230a includes display 260a, sensory indicator 230b includes lights 262b, and sensory indicator 230c includes display 260c.

In such an implementation, sensory indicator 230a, sensory indicator 230b, and sensory indicator 230c receive beacon 210a, beacon 210b, and beacon 210c, respectively, when user 201a, user 201b, and user 201c are within a defined proximity of the respective sensory indicators. In response to receiving the respective triggering signals, sensory indicator 230a, sensory indicator 230b, and sensory indicator 230c may access user information stored on their respective sensory memories, may request user information from the respective beacons, and/or may request user information 217c from server 250. Utilizing the user information, each sensory indicator 230a, sensory indicator 230b, and sensory indicator 230c may determine a personalized sensory response for each user 201a, user 201b, and user 201c, respectively.

For example, sensory indicator 230a may determine that user 201a is a fan of “CHARACTER1” and may present a video clip on display 260a of “CHARACTER1” directing user 201a to a location in environment 280 where there are products known to be favorable to user 201a. Sensory indicator 230b may determine that user 201b is interested in online shooter video games, and may generate a lighting sequence along the floor of environment 280 to direct user 201b to the video game section of environment 280. Sensory indicator 230c may determine that user 201c previously purchased products featuring a certain franchise, “FRANCHISE1”. In response, sensory indicator 230c may present a personalized video clip utilizing a character from “FRANCHISE1” to encourage user 201c to purchase a product featuring “FRANCHISE1”. As such, each sensory indicator 230a, sensory indicator 230b, and sensory indicator 230c may create a personalized sensory response for each respective user 201a, user 201b, and user 201c.

In such an implementation, if user 201a, user 201b, and user 201c were to rotate locations within environment 280, each sensory indicator 230a, sensory indicator 230b, and sensory indicator 230c would create a different personalized sensory response for each user 201a, user 201b, and user 201c based on the respective user information.

In some implementations, there may be a large number of users within environment 280. In such an implementation, server 250 may generate groups of the users who share similar interests using user information 217c, and transmit suitable sensory responses 140b to each of sensory indicator 230a, sensory indicator 230b, and sensory indicator 230c in order to attract individual groups to certain locations within environment 280, thereby reducing overcrowding of any individual location within environment 280.

In yet another implementation, user 201a may be a parent and user 201b a child of user 201a. Beacon 201a may be a cell phone owned by the parent and beacon 210b may be an electronic bracelet worn by the child. In such an implementation, sensory indicator 230a may transmit a notification to beacon 210a in possession of the parent, and notify the parent of a coupon for a product in the location of sensory indicator 230b that the child has triggered with beacon 201b. As a result, the parent is able to buy gifts or be aware of products that are of interest to the child based on the childs navigation through environment 280.

It should be noted that although the implementation of FIG. 2 illustrates three beacons, three sensory indicators, and one server 150, the present disclosure is not limited to the implementation of FIG. 2. In other implementations, there may be any number of beacons, sensory indicators, and servers in communication with each other. For example, in one implementation, there may be multiple beacons transmitting triggering signals to each of sensory indicator 230a, sensory indicator 230b, and sensory indicator 230c. For another example, in another implementation, each of beacon 210a, beacon 210b, and beacon 210c may be transmitted to multiple sensory indicators.

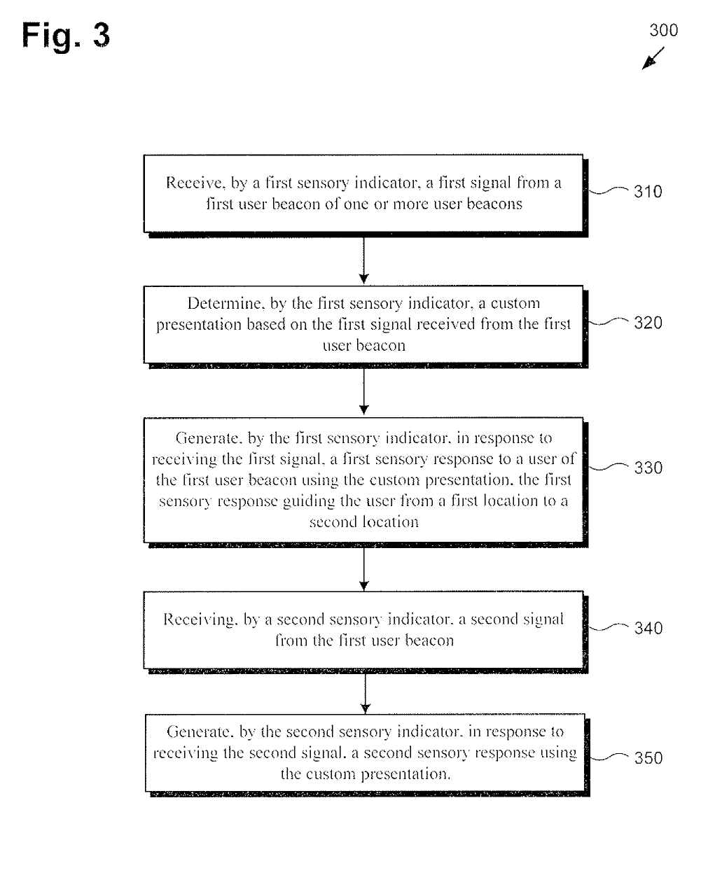

Now referring to FIG. 3. FIG. 3 shows a flowchart illustrating a method of providing a personalized venue experience, according to one implementation of the present disclosure. The approach and technique indicated by flowchart 300 are sufficient to describe at least one implementation of the present disclosure, however, other implementations of the disclosure may utilize approaches and techniques different from those shown in flowchart 300. Furthermore, while flowchart 300 is described with respect to FIG. 2, the disclosed concepts are not intended to be limited by specific features shown and described with respect to FIG. 2.

Referring now to flowchart 300 of FIG. 3, flowchart 300 (at 310) includes receiving, by a first sensory indicator, a first signal from a first user beacon of one or more user beacons. For example, sensory indicator 230a receives a beacon ID from beacon 210a of user 201a. The beacon ID may be similar to beacon ID 118 of beacon 110 in FIG. 1.

Flowchart 300 (at 320) includes determining, by the first sensory indicator, a custom or personal presentation, such as by incorporation of an animation, a movie character, items, places, hobbies, which are appealing to user 201a, based on the first signal received from the first user beacon. For example, sensory indicator 230a determines an animation character that user 201a likes based on the beacon ID sent from beacon 210a. Sensory indicator 230a may compare the beacon ID to beacon ID data 134a of FIG. 1 to determine an identity of user 201a. Once the identity of user 201a is determined, sensory indicator 230a may access user information of user 201a to determine a favorite character, item, place and/or hobby of user 201a for incorporating into a custom presentation to user 201a. The user information of user 201a may be obtained from user information 235b received by server 250, user information stored on sensory indicator 230a such as user information 135a of FIG. 1, and/or user information received from beacon 210a such as user information 117 of FIG. 1. Once the user information is obtained by sensory indicator 230a, sensory indicator 230a may select a character, such as “CHARACTER1”, from a favorite character list of user 201a, for example.

Referring again to flowchart 300 of FIG. 3, flowchart 300 (at 330) includes generating, by the first sensory indicator, in response to receiving the beacon ID, a first sensory response to a user of the first user beacon using the custom presentation, the first sensory response guiding the user from a first location to a second location. For example, in response to receiving the beacon ID from beacon 210a, sensory indicator 230a generates a sensory response to user 201a, where the sensory response guides user 201a from the location of sensory indicator 230a in environment 280 to a second location within environment 280, such as the location of sensory indicator 230b. The sensory response generated by sensory indicator 230a may be one of sensory responses 240b received from server 250 or may be one of sensory responses stored on sensory indicator 230a, such as sensory responses 140a of FIG. 1.

In one example, “CHARACTER1” may appear on a short video clip on display 260a and verbally direct user 201a in the direction of sensory indicator 230b. “CHARACTER1” may say, “Welcome user 201a, head to the back left of the store to see all my cool new toys, I'll meet you over there.”

Next, flowchart 300 (at 340) includes receiving, by a second sensory indicator, a second signal from the first user beacon. For example, sensory indicator 230b receives a second triggering signal from beacon 210b, including the beacon ID.

Flowchart 300 (at 350) includes generating, by the second sensory indicator, in response to receiving the second signal, a second sensory response using the custom presentation. For example, in response to receiving the beacon ID from beacon 210b, sensory indicator 230b generates a sensory response to user 201b in possession of beacon 210b. The sensory response generated by sensory indicator 230b may be one of sensory responses 240b received from server 250 or may be one of sensory responses stored on sensory indicator 230a, such as sensory responses 140a of FIG. 1. Further, in one implementation, system 200 records or maintains a feedback as to whether user 201a who was directed to sensory indicator 230b in fact arrived at sensory indicator 230b or not. This feedback may be used by system 200 for improving interactions with the users.

To determine the proper sensory response, sensory indicator 230b may utilize the user information of user 201b in conjunction with sensory data, such as sensory data 236b received from server 250, and/or sensory data stored on sensory indicator 230b, such as sensory data 136a of FIG. 1. For example, sensory indicator 230b may determine the identity of user 201b and access user information of user 201b to determine again that user 201b likes “CHARACTER1”. The user information of user 201b may be obtained from user information 235b received by server 250, user information stored on sensory indicator 230b such as user information 235a of FIG. 1, and/or user information received from beacon 210b such as user information 11a of FIG. 1. In addition, or in the alternative, sensory indicator 230b may access the sensory data and determine that user 201b previously, at the location of user 201a in environment 280, was directed to the location of sensory indicator 230b by sensory indicator 230a using “CHARACTER1”. Once the sensory data is retrieved and the user information is retrieved, sensory indicator 230b may present an appropriate sensory response to user 201b using “CHARACTER1” that logically follows the first sensory response generated by sensory indicator 230a, discussed above.

For example, upon arriving at the location of sensory indicator 230b, and after beacon 210b sends the triggering signal to sensory indicator 230b, sensory indicator 230b generates a sensory response selected from one of sensory responses 240b received from server 250 or one of sensory responses stored on sensory indicator 230a, such as sensory responses 140a of FIG. 1. Continuing with the sensory response generated by sensory indicator 230a, the sensory response of sensory indicator 230b may include “CHARACTER1” saying, in a short video clip, “Thanks for coming to see me back here user 201a, look at all my great toys, and don't forget to look at ‘ITEM-X’ because it is on sale for today only!” As such, user 201b is guided through environment 280 to locations of interest of user 201b based on user information of user 201b, in order to provide a personalized experience for user 201 in environment 280.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A system for use with one or more user beacons, the system comprising:
a plurality of sensory indicators including a first sensory indicator at a first location and a second sensory indicator at a second location;
the first sensory indicator configured to:
receive a first signal from a first user beacon of the one or more user beacons;
determine a custom presentation based on the first signal received from the first user beacon;
generate, in response to receiving the first signal, a first sensory response to the user of the first user beacon using the custom presentation, the first sensory response guiding the user from the first location to the second location; and the second sensory indicator configured to:
receive a second signal from the first user beacon;
generate, in response to receiving the second signal, a second sensory response using the custom presentation.

2. The system of claim 1, wherein the determining the custom presentation based on the first signal includes:
obtaining, in response to receiving the first signal, user information of the first user; and
selecting the custom presentation based on the user information of the first user.

3. The system of claim 2, wherein the user information is obtained from at least one of the first user beacon and a server in communication with the system.

4. The system of claim 2, wherein the user information includes at least one of a purchasing history, a profile information, and a viewing history.

5. The system of claim 1, wherein the first sensory indicator is a display and the first sensory response is a video clip including the custom presentation presented on the display, and wherein the custom presentation includes a favorite character of the first user.

6. The system of claim 5, wherein the display is one of a television, a projector, and a holographic display.

7. The system of claim 1, wherein the first sensory indicator includes a plurality of lights and the second sensory response is a light sequence.

8. The system of claim 1, wherein the custom presentation includes one of a fictional character and a real-life character.

9. The system of claim 1, wherein the first location and the second location are locations within a store.

10. The system of claim 1, wherein first user beacon is included in one of an electronic bracelet and a cell phone.

11. A method for use with one or more user beacons and a plurality of sensory indicators including a first sensory indicator at a first location and a second sensory indicator at a second location, the method comprising:
receiving, by the first sensory indicator, a first signal from a first user beacon of the one or more user beacons;
determining, by the first sensory indicator, a custom presentation based on the first signal received from the first user beacon;
generating, by the first sensory indicator, in response to receiving the first signal, a first sensory response to the user of the first user beacon using the custom presentation, the first sensory response guiding the user from the first location to the second location;
receiving, by the second sensory indicator, a second signal from the first user beacon; and
generating, by the second sensory indicator, in response to receiving the second signal, a second sensory response using the custom presentation.

12. The method of claim 11, wherein the determining the custom presentation based on the first signal includes:
obtaining, in response to receiving the first signal, user information of the first user; and
selecting the custom presentation based on the user information of the first user.

13. The method of claim 12, wherein the user information is obtained from at least one of the first user beacon and a server in communication with the system.

14. The system of claim 12, wherein the user information includes at least one of a purchasing history, a profile information, and a viewing history.

15. The method of claim 11, wherein the first sensory indicator is a display and the first sensory response is a video clip including the custom presentation presented on the display, and wherein the custom presentation includes a favorite character of the first user.

16. The method of claim 15, wherein the display is one of a television, a projector, and a holographic display.

17. The method of claim 11, wherein the first sensory indicator includes a plurality of lights and the second sensory response is a light sequence.

18. The method of claim 11, wherein the custom presentation includes one of a fictional character and a real-life character.

19. The method of claim 11, wherein the first location and the second location are locations within a store.

20. The method of claim 11, wherein first user beacon is included in one of an electronic bracelet and a cell phone.
